(19) United States
(12) Patent Application Publication
(10) Pub. No.: US 2013/0307504 A1
(43) Pub. Date: Nov. 21, 2013

(54) VOLTAGE GENERATION CIRCUIT

(71) Applicant: FUJITSU SEMICONDUCTOR LIMITED, Yokohama-shi (JP)

(72) Inventor: Takahiko SATO, Tachikawa (JP)

(73) Assignee: FUJITSU SEMICONDUCTOR LIMITED, Yokohama-shi (JP)

(21) Appl. No.: 13/872,771

(22) Filed: Apr. 29, 2013

(30) Foreign Application Priority Data
May 21, 2012 (JP) 2012-115431

(51) Int. Cl. G05F 1/10

(52) U.S. Cl. CPC G05F 1/10
USPC 323/282

(57) ABSTRACT

A voltage generation circuit has N sets of voltage step-up circuits configured to start a voltage step-up operation for increasing an absolute value of an output voltage and configured to stop the voltage step-up operation when the output voltage reaches a step-up voltage that is independently set for each voltage step-up circuit; and a control circuit configured to control such that the N sets of voltage step-up circuits operate in accordance with order of priority while limiting a maximum number of voltage step-up circuits that simultaneously operate, out of the N sets of voltage step-up circuits, to a plural number lower than the N sets.

### CROSS-REFERENCE TO RELATED APPLICATION

This application is based upon and claims the benefit of priority of the prior Japanese Patent Application No. 2012-115431, filed on May 21, 2012, the entire contents of which are incorporated herein by reference.

### FIELD

The present invention relates to a voltage generation circuit.

### BACKGROUND

A voltage generation circuit is a circuit to generate an output voltage having a desired potential based on a power supply voltage. Integrated circuits in recent years include a plurality of internal power supply voltages, and the plurality of internal power supply voltages have been used in various portions in the integrated circuits. Accordingly, the voltage generation circuits to generate the internal power supply voltages are provided in the integrated circuit.

The voltage generation circuit includes a positive voltage step-up circuit, which steps up a predetermined power supply voltage higher to generate a positive output voltage having a high potential, and a negative voltage step-up circuit, which steps up a predetermined power supply voltage on the negative potential side lower than a reference voltage like a ground voltage to generate a negative output voltage having a highly negative potential. Further, the voltage generation circuit includes a voltage step-down circuit that steps down a predetermined supply power voltage to generate a positive output voltage. With respect to any of the voltage step-up circuits, when a power supply is turned on, or when returned from a sleep state, the output voltage is stepped up from a ground potential to a positive potential (or stepped up to a negative potential). When the output voltage reaches a desired potential, the voltage step-up operation is stopped. Moreover, the voltage step-down circuit raises the output voltage from the ground potential to a desired positive potential. After the internal power supply startup operation, when the absolute value of the output voltage is reduced from the desired step-up potential due to current consumption of internal circuits, the voltage step-up circuit restarts the voltage step-up operation again and returns the output voltage to the desired potential, or the voltage step-down circuit operates in such a manner as to keep the output voltage at the desired potential.

Japanese Unexamined Patent Application Publication No. 2010-57230, Japanese Unexamined Patent Application Publication No. 2004-248475, Japanese Unexamined Patent Application Publication No. 2010-135015, and Japanese Unexamined Patent Application Publication No. 07-182862 disclose the voltage step-up circuit.

With respect to the internal power supply startup sequence when a power supply is turned on or when returned from a sleep state, there occurs a case where the order of high-and-low levels of the potential of the voltage value of each internal power supply is different from a desired order of high-and-low levels of the potential due to the inadequate adjustment of the generation speed of each internal power supply. Nodes having the voltage value of the internal power supply are provided in various portions in the internal circuits. Accordingly, when the order of high-and-low levels of the potential of the voltage value of each internal power supply is different from the desired order, the operation of the internal circuits may operate inadequately.

For example, in some case, the back-gate bias potential of a MOS transistor becomes a potential to forward-bias a source-drain parasitic PN junction to cause a leak current. In other case, the gate voltage of the transistor of a CMOS inverter becomes higher or lower than the source voltage and a cut-off of the transistor becomes inappropriate to cause a leak current.

Thus, when the plurality of internal power supply voltages are started up, it is demanded to prevent the order of high-and-low levels of aforementioned undesirable potentials from being generated.

Further, the simultaneous activation of a plurality of voltage generation circuits to generate a plurality of internal power supply voltages causes a substantial consumption current and causes power supply noise, whereby there occurs undesirable fluctuation in the internal power supply voltages that serve as output voltages. In this case also, the operation of the internal circuits becomes inappropriate.

### SUMMARY

According to one aspect of the present invention, a plurality of output voltages are prevented from fluctuating at undesirable potentials, and the absolute value of the plurality of output voltages are stepped up in the desirable order of high-and-low levels of the potentials.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a circuit diagram to illustrate a cut-off control of a CMOS inverter circuit.

FIG. 2 is a circuit diagram to illustrate a back-gate bias voltage in the CMOS inverter circuit.

FIG. 3 is a circuit diagram to illustrate an NMOS transistor N5 to short-circuit two negative power supply voltages vn2 and vn3.

FIG. 4 is a circuit diagram of the voltage generation circuit to generate a negative internal power supply voltage.

FIG. 5 is a circuit diagram of the voltage generation circuit to generate a positive internal power supply voltage.

FIG. 6 is a circuit diagram of a voltage step-down circuit.

FIG. 7 is a circuit diagram of a feedback voltage step-down circuit.

FIG. 8 is an overall configuration diagram of the memory circuit.

FIG. 9 is a circuit diagram of the memory cell array.

FIG. 10 is a circuit diagram of an inverter INV, a NOR gate, and a NAND gate in the peripheral control circuit group.

FIG. 11 is an overall configuration diagram of the voltage generation circuit of the embodiment of the present invention.

FIG. 12 is a circuit diagram of the interrupt control circuit 92 of the embodiment of the present invention.

FIG. 13 is a timing chart of internal power supply startup sequence illustrated as one example.

FIG. 14 is a circuit diagram of the startup control circuit.

FIG. 15 is a graph of the startup sequence of the voltage step-up circuits, illustrated as another example.

FIG. 16 is a graph of the startup sequence of the voltage step-up circuits, illustrated as another example.

### DESCRIPTION OF EMBODIMENTS

It is presupposed that “x” at the end of characters of each signal indicates that L level is in an activated state (active), and “z” at the end of characters of each signal indicates that H level is in the activated state (active).

[Various Internal Power Supply Voltage]

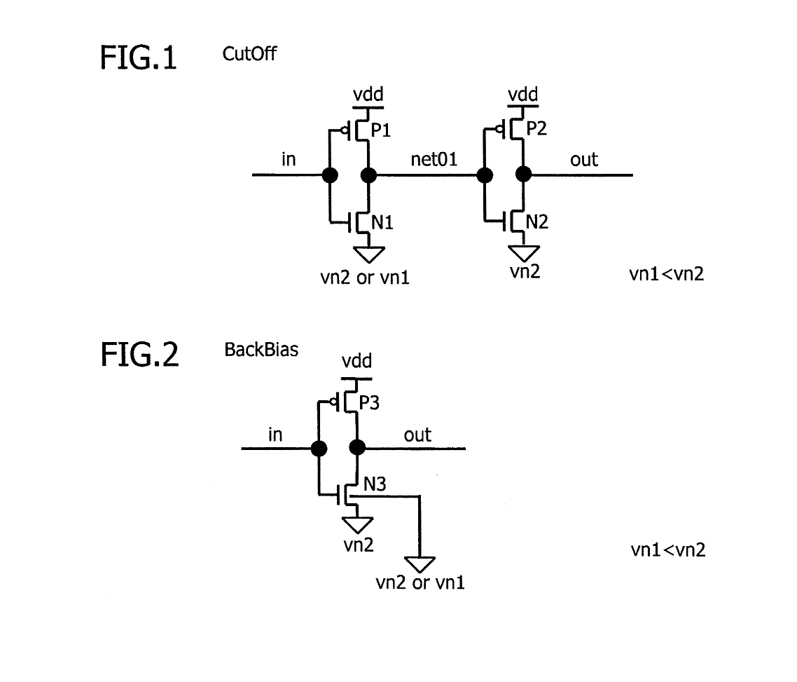

FIG. 1 is a circuit diagram to illustrate a cut-off control of a CMOS inverter circuit. In FIG. 1, the CMOS inverter circuit includes a primary stage inverter made up of a PMOS transistor P1 and an NMOS transistor N1, and a secondary stage inverter made up of a PMOS transistor P2 and an NMOS transistor N2. In response to an input in, the primary stage inverter outputs an inverting output net01, and in response to the output of the primary stage inverter, the secondary stage inverter outputs an inverting output out. When the input in is at H level, the NMOS transistor N1 in the primary stage inverter is turned on, and the potential of the inverting output net01 becomes equal to that of the source power supply for the NMOS transistor N1. Based on the inverting output net01 at L level, in the secondary stage inverter, the NMOS transistor N2 is turned off, and the PMOS transistor P2 is turned on, and the inverting output outreaches H level.

In this case, in order to completely cut off the NMOS transistor N2 in the secondary stage inverter and prevent a standby leak current flowing from a high power supply vdd to a low power supply vn2 via the PMOS transistor P2 in an ON state, it is demanded to keep the inverting output net01 at a potential lower than that of the source power supply vn2 for the NMOS transistor N2. In other words, it is demanded to keep the source power supply vn1 for the NMOS transistor N1 at a potential lower than that of the source power supply vn2 for the NMOS transistor N2, that is, to keep vn1<vn2. Even in the case where a slight amount of standby leak current is allowable for the NMOS transistor N2, at least, it is demanded to equate the source power supply voltage vn1 for the NMOS transistor N1 with the source power supply voltage vn2 for the NMOS transistor N2 in the secondary inverter, in order to logically operate in a normal way.

In particular, when the size of the NMOS transistor N2 in the secondary stage inverter is large, the standby leak current increases so as to exceed allowable limits, which is not preferable in terms of electric power saving. In this case, the aforementioned vn1<vn2 is preferable, which needs two sets of the source power supplies vn1 and vn2 in the two-stages CMOS inverter circuit.

FIG. 2 is a circuit diagram to illustrate a back-gate bias voltage in the CMOS inverter circuit. In FIG. 2, the CMOS inverter circuit made up of a PMOS transistor P3 and an NMOS transistor N3. Focusing on the NMOS transistor N3, the back-gate bias voltage vn1 of the NMOS transistor N3 is demanded to be equal to or lower than the source power supply voltage vn2 for the NMOS transistor N3, that is, vn1=vn2, or vn1<vn2, in such a manner as not to forward-bias a parasitic PN diode between the source and the back gate (P well area). When forward-biased, a leak current occurs from the back gate to the source.

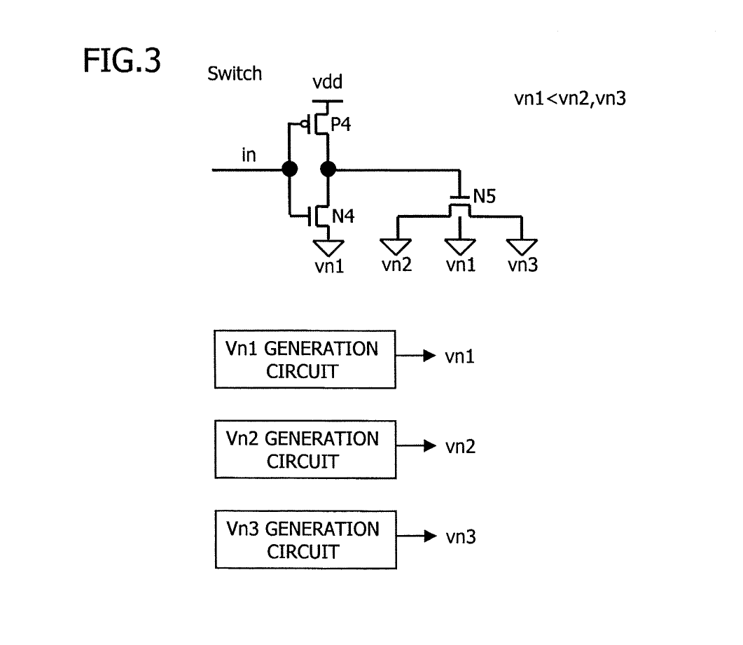

FIG. 3 is a circuit diagram to illustrate an NMOS transistor N5 to short-circuit two negative power supply voltages vn2 and vn3. It is presupposed that two negative power supply voltages vn2 and vn3 are generated in an LSI, and that a vn2 generation circuit to generate the negative power supply voltage vn2 and a vn3 generation circuit to generate the negative power supply voltage vn3 have a little power supply driving ability.

In the case above, there is a case where a negative power supply voltage generated by short-circuiting the two negative power supply voltages vn2 and vn3 is utilized for some purposes in test operations or power supply startup operations. For example, the negative power supply voltages vn2 and vn3 are used as the combination of the negative power supply voltage of word lines and the back-gate voltage of memory transistors in a memory circuit.

In this case, the output signal of the CMOS inverter circuit, which is made up of a PMOS transistor P4 and an NMOS transistor N4, is supplied to the gate of the NMOS transistor N5 to be short-circuited, whereby carrying out ON/OFF control. When control is performed in such a manner that the relation of high- and low levels of potentials between the two negative power supply voltages vn2 and vn3 is reversed in the operational states, it is demanded to keep the back-gate bias voltage vn1 for the NMOS transistor N5 at a voltage equal to or lower than the lower one out of the two negative power supply voltages vn2 and vn3, as represented as vn1<vn2, vn3.

As illustrated in FIGS. 1, 2, and 3, in order to completely cut off the transistors when increasing the standby leak current of the transistors whose size is very small in the highly integrated LSI, it is demanded to additionally generate a low negative source power supply inside, which has not been demanded heretofore. Further, the back-gate bias voltage of the NMOS transistor coupled to the negative source power supply or the transistor that short-circuits between two negative power supply voltages needs to be a negative voltage lower than the voltage of the negative source power supply, or needs to be a negative voltage lower than the two negative power supply voltages. Accordingly, the negative voltage needs to be additionally generated inside. Thus, the number of internal power supplies in the integrated circuits tends to increase in recent years. In particular, an increase in the number of negative power supplies necessitates more careful power supply control in a manner as to maintain the order of high-and-low levels of the negative power supply voltages in the internal power supply startup sequence, which has not been demanded heretofore.

[Example of Voltage Generation Circuit]

Next, the example of the voltage generation circuit to generate an internal power supply voltage will be described below.

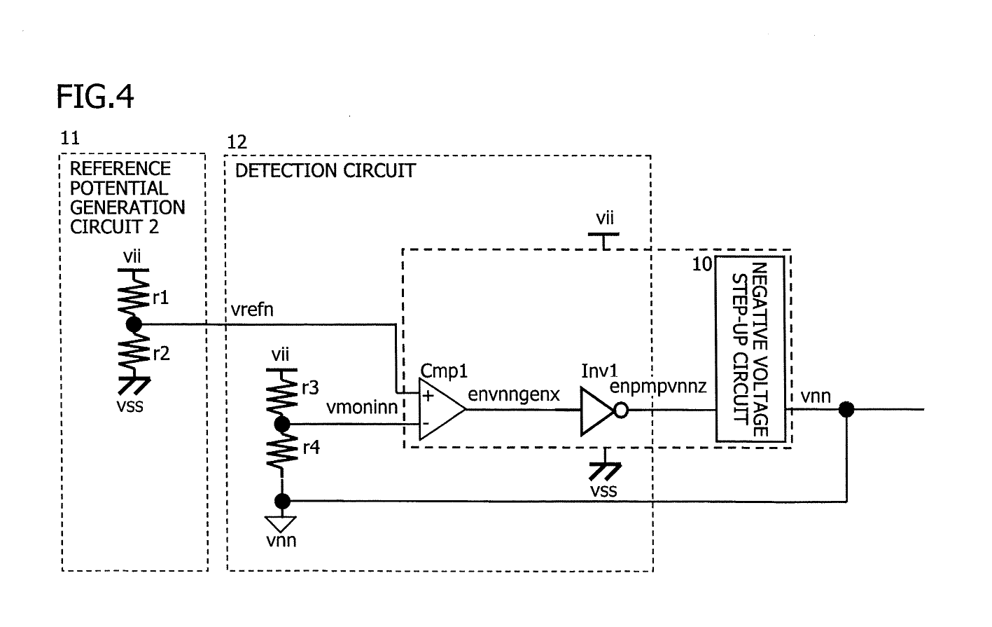

FIG. 4 is a circuit diagram of the voltage generation circuit to generate a negative internal power supply voltage. The voltage generation circuit in FIG. 4 generates a negative voltage vnn. The voltage generation circuit includes a negative voltage step-up circuit 10 to step up an internal power supply voltage vii to a negative potential side to generate the negative voltage vnn when a voltage step-up (pumping) enable signal enpmpvnnz is in the activated state (H level), a comparator Cmp1 to compare the monitor voltage vmoninn of the negative voltage vnn with a reference voltage vrefn, and an inverter Inv1. The internal power supply voltage vii is supplied to the negative voltage step-up circuit 10, the comparator Cmp1, and the inverter Inv1.

A reference potential generation circuit 11 generates the reference voltage vrefn divided by the resistance of resistors r1 and r2 provided between the internal power supply voltage vii and a ground voltage vss. A detection circuit 12 generates the monitor voltage vmoninn divided by the resistance of resistors r3 and r4 provided between the negative voltage vnn to be outputted and the internal power supply voltage vii and includes the comparator Cmp1 to compare the monitor voltage vmoninn with the reference voltage vrefn and the inverter Inv1 to invert the output of the comparator Cmp1.

For example, when the negative voltage vnn to be outputted becomes shallower from a desired negative potential (closer to the ground potential), the monitor voltage vmoninn increases, and the output envnngenx of the comparator Cmp1 is reduced into the activated state (L level), and the voltage step-up enable signal enpmpvnnz is activated (H level) by the inverter Inv1, whereby the negative voltage step-up circuit 10 starts the voltage step-up operation. Accordingly, the potential of the negative voltage vnn to be outputted becomes deeper to the negative potential side and is controlled to be the desired negative potential. When the negative voltage vnn reaches the desired negative potential, the output envnngenx of the comparator Cmp1 increases into the inactivated state (H level), whereby the negative voltage step-up circuit 10 stops the voltage step-up operation. The monitor voltage vmoninn and the reference voltage vrefn are generated based on the internal power supply voltage vii as a reference.

The voltage generation circuit of FIG. 4 uses not an external power supply vdd as a high potential power supply, but the internal power supply voltage vii as the high potential power supply. This is because the external power supply vdd is a power supply whose fluctuation is substantial, so that the monitor voltage vmoninn generated by a monitor voltage generation circuit made up of the resistors r3 and r4 and the reference voltage vrefn generated by the reference potential generation circuit 11 are affected by the fluctuation of the external power supply vdd, and the potential of the negative voltage vnn to be outputted is also affected and varied. Accordingly, the external power supply vdd is not used as the high potential power supply, but the internal power supply vii is used as the high potential power supply because the internal power supply vii provides a steady voltage whose value is set based on the ground as a reference in the integrated circuit device.

However, when in the power supply startup sequence when the external power supply is turned on or when returned from a sleep state, a plurality of negative voltage step-up circuits simultaneously operate, a large amount of current flows in the internal power supply vii, whereby power supply noise occurs. When the power supply noise occurs in the internal power supply vii, there occurs the fluctuation of potentials of the negative voltage vnn to be outputted for the same reason above. Accordingly, it is demanded to control in such a manner not to increase the consumption current of the voltage generation circuit in the power supply startup sequence. In other words, as the number of voltage step-up circuits that simultaneously carry out the voltage step-up operation increases, the peak current increases, the noise occurs in the internal power supply vii, and the potential of the negative voltage vnn to be outputted fluctuates. Consequently, it is demanded to limit the number of voltage step-up circuits that simultaneously operate.

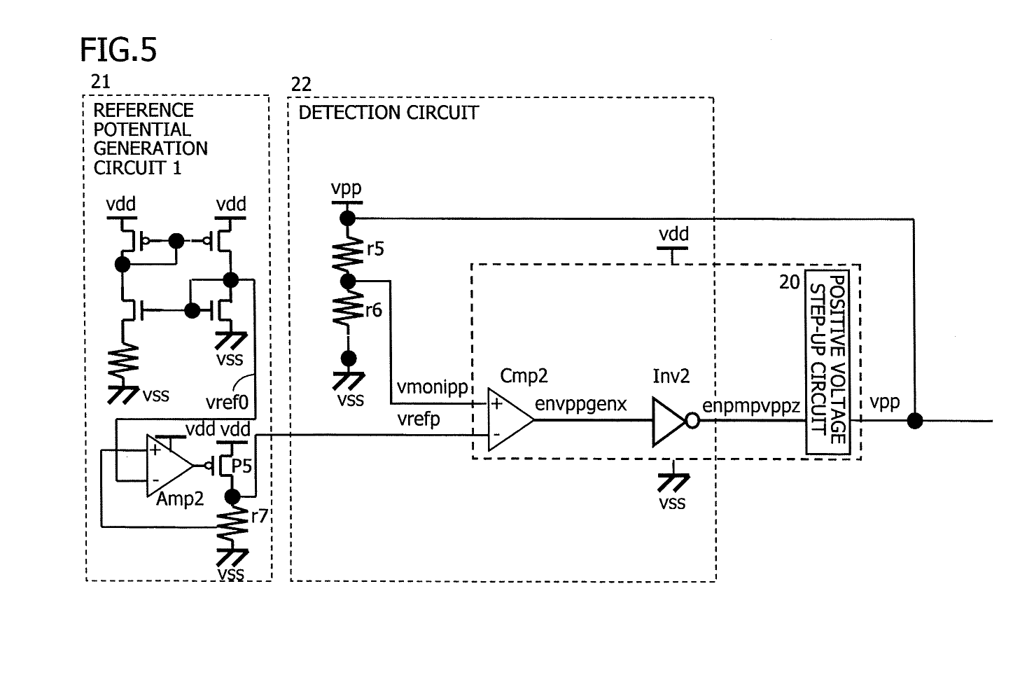

FIG. 5 is a circuit diagram of the voltage generation circuit to generate a positive internal power supply voltage. The voltage generation circuit in FIG. 5 generates a positive voltage vpp. The voltage generation circuit includes a positive voltage step-up circuit 20 to step up the external power supply voltage vdd to a positive potential side to generate the positive voltage vpp when a voltage step-up (pumping) enable signal enpmpvppz is in an activated state (H level), a comparator Cmp2 to compare the monitor voltage vmonipp of the positive voltage vpp with a reference voltage vrefp, and an inverter Inv2. The external power supply voltage vdd is supplied to the positive voltage step-up circuit 20, the comparator Cmp2, and the inverter Inv2.

A reference potential generation circuit 21 generates the reference voltage vref0 to which the dependency on temperature is suppressed by the circuits illustrated, and generates a reference voltage vrefp by multiplying the reference voltage vref0 by the division ratio of the resistances according to an operational amplifier Amp2, a PMOS transistor P5, and a resistor r7. On the other hand, a detection circuit 22 includes the comparator Cmp2 to compare the monitor voltage vmonipp, which is generated by a monitor voltage generation circuit made up of resistors r5 and r6 provided between the positive voltage vpp to be outputted and the ground voltage vss, with the reference voltage vrefp, and the inverter Inv2 to invert the output of the comparator Cmp2.

For example, when the positive voltage vpp to be outputted is reduced lower than a desired positive potential, the monitor voltage vmonipp decreases, and the output envppgenx of the comparator Cmp2 decreases into an activated state (L level), and the voltage step-up enable signal enpmpvppz is put into the activated state (H level) by the inverter Inv2, whereby the positive voltage step-up circuit 20 starts voltage step-up operation. Accordingly, the positive voltage vpp to be outputted is controlled to increase on the positive potential side to the desired potential. When the positive voltage vpp reaches the desired positive potential, the output envppgenx of the comparator Cmp2 increases into the inactivated state (H level), whereby the positive voltage step-up circuit 20 stops the voltage step-up operation.

In the case of the positive voltage generation circuit, also when the number of circuits that simultaneously carry out the voltage step-up operation increases, the peak current increases, which undesirably leads to the fluctuation of the power supply voltage vdd and leads to the fluctuation of potentials of the positive voltage vpp to be outputted.

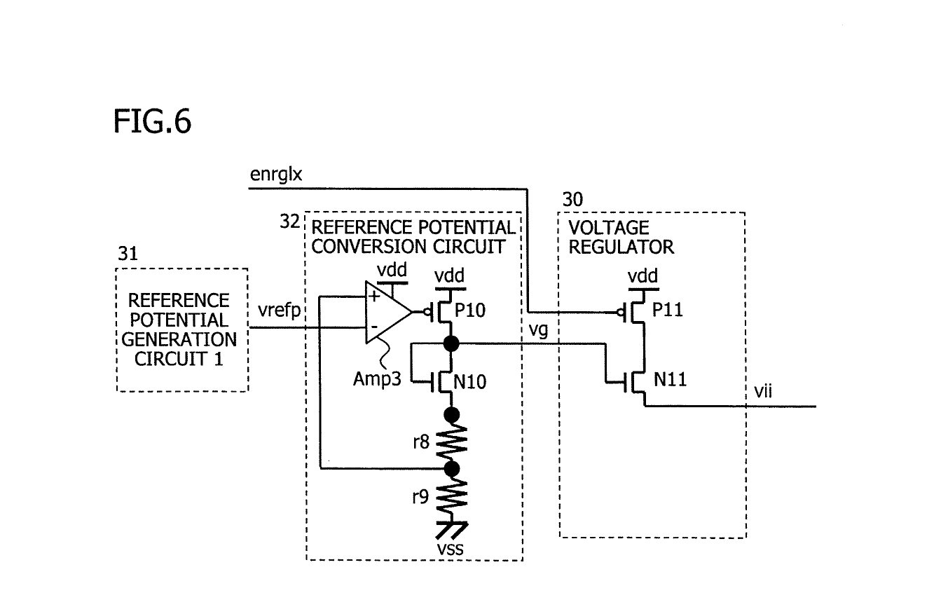

FIG. 6 is a circuit diagram of a voltage step-down circuit. The voltage step-down circuit is a circuit to generate a positive internal power supply voltage vii by reducing the external power supply voltage vdd. The voltage step-down circuit includes a voltage regulator 30 including a PMOS transistor P11 and an NMOS transistor N11, a reference potential generation circuit 31, and a reference potential conversion circuit 32.

The reference potential generation circuit 31, which is similar to the circuit of FIG. 5, generates a positive reference potential vrefp. The reference potential conversion circuit 32 includes an operational amplifier Amp3, a PMOS transistor P10, an NMOS transistor N10, and resistors r8 and r9 and multiplies the reference potential vrefp by (r8+r9)/r9 and converts into a voltage vg to which the threshold voltage of the NMOS transistor N10 is added. In the voltage regulator 30, when a regulator enable signal enrglx is in the activated state (L level), the PMOS transistor P11 is turned on, whereby outputting the internal power supply voltage vii lower than the conversion voltage vg by the threshold voltage of the NMOS transistor N10.

When the current provided from the internal power supply vii is consumed, the internal power supply voltage vii decreases. When the conversion voltage vg is maintained, the current is supplied to the internal power supply vii in a manner as to maintain a gate-source voltage Vgs of the NMOS transistor N11 of the voltage regulator 30, thereby keeping the voltage value of the internal power supply voltage vii to be outputted at a desired potential.

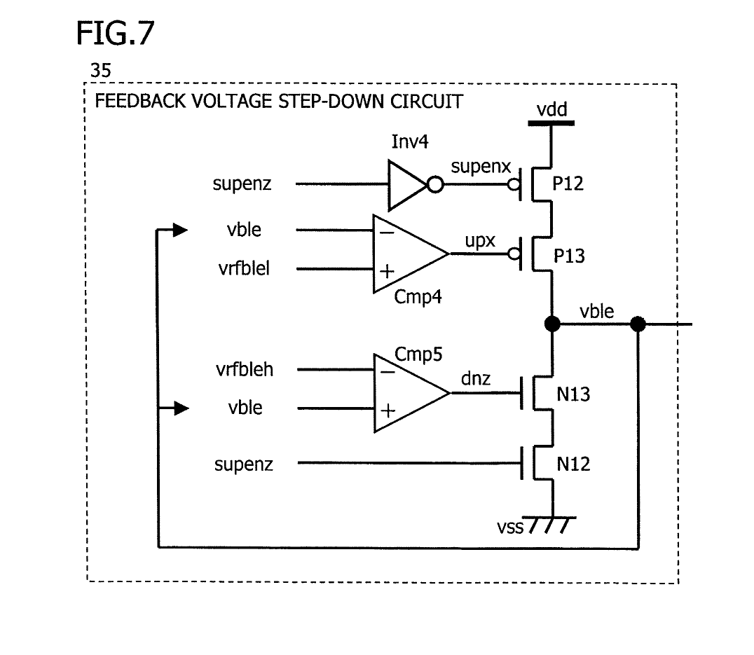

FIG. 7 is a circuit diagram of a feedback voltage step-down circuit. The feedback voltage step-down circuit includes PMOS transistors P12 and P13, NMOS transistors N12 and N13, comparators Cmp4 and Cmp5, and an inverter Inv4. For example, the feedback voltage step-down circuit generates an equalized voltage vble of bit lines in a memory circuit like DRAM. The equalized voltage vble to be output is fed back to the two comparators Cmp4 and Cmp5 in a manner that the equalized voltage vble is controlled between an H-level-side reference voltage vrefbleh and an L-level-side reference voltage vrefblel. When an enable signal supenz is in the activated state (H level), the transistors P12 and N12 are conducted, and the feedback voltage step-down circuit is turned into an operating state. The two reference potentials are provided for preventing the current leak from the high potential power supply vdd to the ground power supply vss via the PMOS transistors P12 and P13 and the NMOS transistors N12 and N13.

For example, when the equalized voltage vble to be output decreases lower than a desired positive potential, the output upx of the comparator Cmp4 is reduced, and the transistor P13 is turned into an ON state, thereby increasing the equalized voltage vble. Conversely, when the equalized voltage vble to be output increases higher than a desired positive potential, the output dnz of the comparator Cmp5 is increased, and the transistor N13 is turned into the ON state, thereby reducing the equalized voltage vble.

The two comparators Cmp4 and Cmp5 illustrated in FIG. 7 correspond to the detection circuit of the feedback voltage step-down circuit, and consequently output respectively the outputs upx and dnz.

[Memory Circuit Including Voltage Generation Circuit]

Next, the memory circuit of DRAM will be described as one example of an integrated circuit wherein a plurality of positive or negative internal power supplies are generated inside to be utilized.

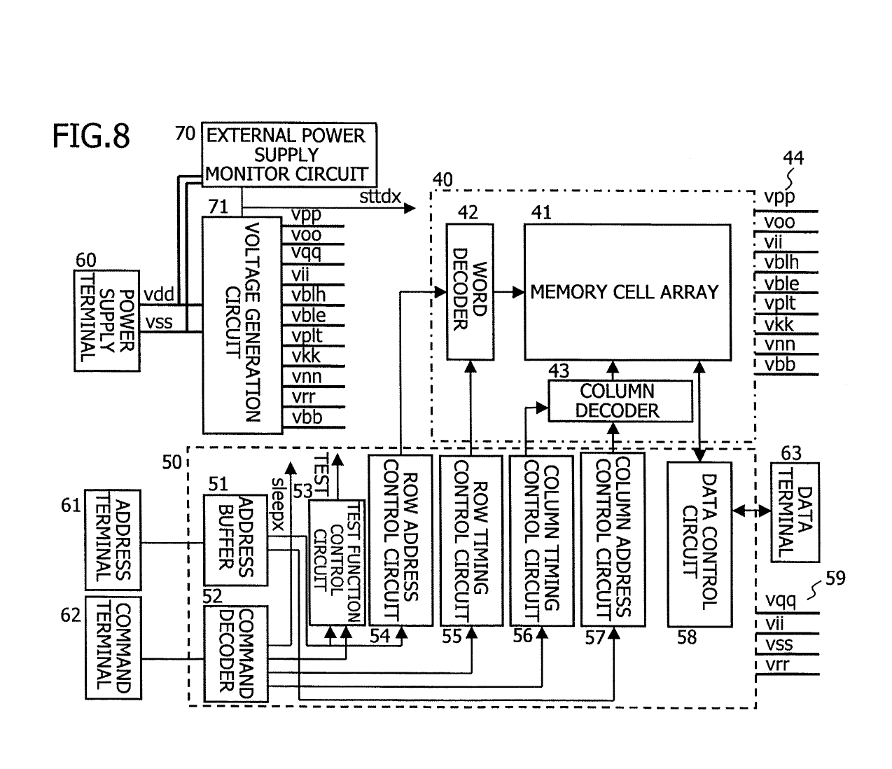

FIG. 8 is an overall configuration diagram of the memory circuit. The memory circuit includes a memory core 40, a peripheral control circuit group 50, an external power supply monitor circuit 70, a voltage generation circuit 71 to generate a plurality of internal power supply voltages, and external terminal groups 60 to 63.

The memory core 40, in which memory cells are disposed in a matrix shape, includes a memory cell array 41 having a sense amplifier and a bit line equalized circuit, a word decoder 42 to select and drive the word line based on a row address, and a column decoder 43 to select the bit line based on a column address.

The external terminal groups include power supply terminals 60 having the high potential power supply vdd and the ground power supply vss, a plurality of address terminals 61, a plurality of command terminals 62, and data terminals 63 to which data are inputted and outputted.

When a power supply is turned on, the external power supply monitor circuit 70 detects the rise of the high potential power supply vdd and puts a power supply startup detection signal sttdx into the activated state (L level). When the rise has completed, the external power supply monitor circuit 70 puts the power supply startup detection signal sttdx into the inactivated state (H level). The high potential power supply vdd and the ground power supply vss are supplied to the voltage generation circuit 71, which generates internal power supply voltages vpp, voo, vqq, vii, vblh, vble, vplt, vkk, vnn, vrr, and vbb. The voltage generation circuit 71 starts the internal power supply startup sequence operation in response to the activated state of the power supply startup detection signal sttdx.

These internal power supply voltages are as follows;

vpp: a positive step-up voltage equal to or higher than vdd

voo: a positive step-up voltage higher than the H level voltage vblh of the bit line

vqq: a back-gate bias voltage of the PMOS transistor of the peripheral control circuit, and a positive step-up voltage higher than vii

vii: a positive voltage lower than vdd

vblh: a H level voltage of the bit line, and a positive voltage lower than vii

vble: an equalized voltage of the bit line and an intermediate voltage between vss and vblh

vplt: a cell plate voltage of the capacitor of the memory cell, and a voltage equivalent to vble

vkk: a L level voltage of the word line, and a negative step-up voltage

vnn: a source power supply voltage of the source of NMOS transistor of the CMOS inverter, and a negative step-up voltage

vrr: a back-gate bias voltage of the NMOS transistor of the peripheral control circuit, and a negative step-up voltage

vbb: a back-gate bias voltage of the transistor of memory cell, and a negative step-up voltage.

Some portions 44 of the aforementioned internal power supply voltages are supplied to the memory core 40, and other portions 59 are supplied to the peripheral control circuit group 50.

The peripheral control circuit group 50 includes an address buffer 51, a row address control circuit 54 to latch the row address, and a column address control circuit 57 to latch the column address. Further, the peripheral control circuit group 50 includes a command decoder 52 to decode the commands, a row timing control circuit 55 to generate a row timing signal in accordance with the decoding result, and a column timing control circuit 56 to generate a column timing signal. The word decoder 42 and the column decoder 43 operate at an optimal timing in response to the respective timing signals.

The peripheral control circuit group 50 is provided between the memory cell array 41 and the data terminals 63 and includes a data control circuit 58 to carry out control of input and output of data. A test function control circuit 53 generates a test mode signal TEST in response to a test command from the command decoder 52.

When the command decoder 52 detects a command to return from a sleep state, a sleep signal sleepx is put into the inactivated state (H level), and the internal circuit group is returned from the sleep state. The voltage generation circuit 71 starts the internal power supply startup sequence operation in response to the inactivated state of the sleep signal sleepx.

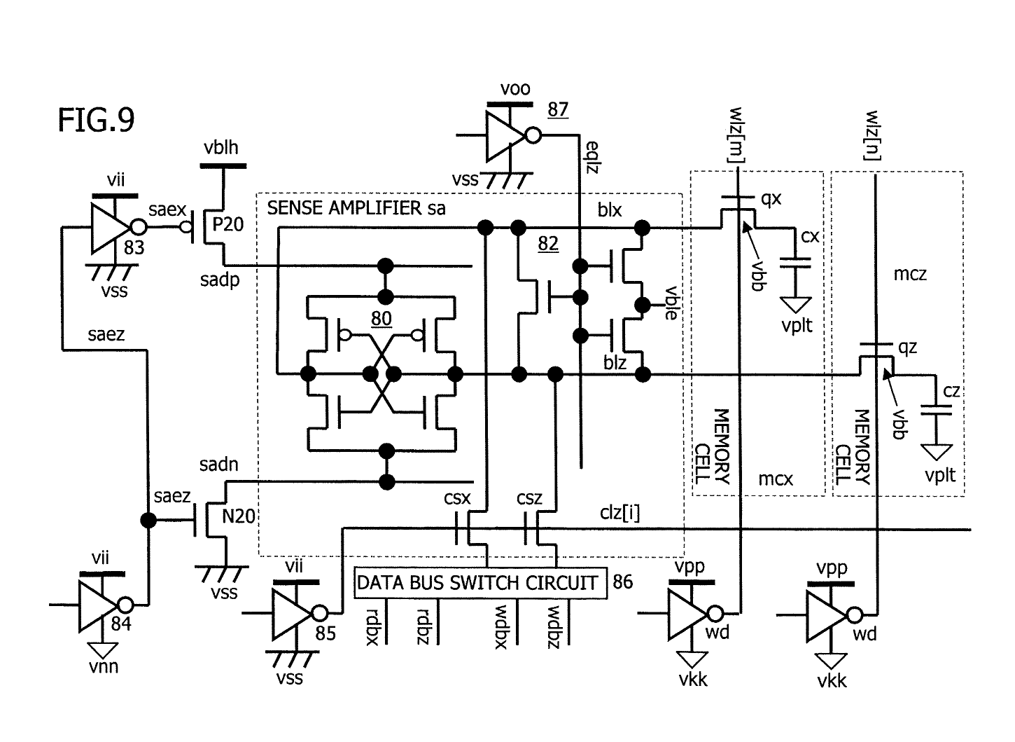

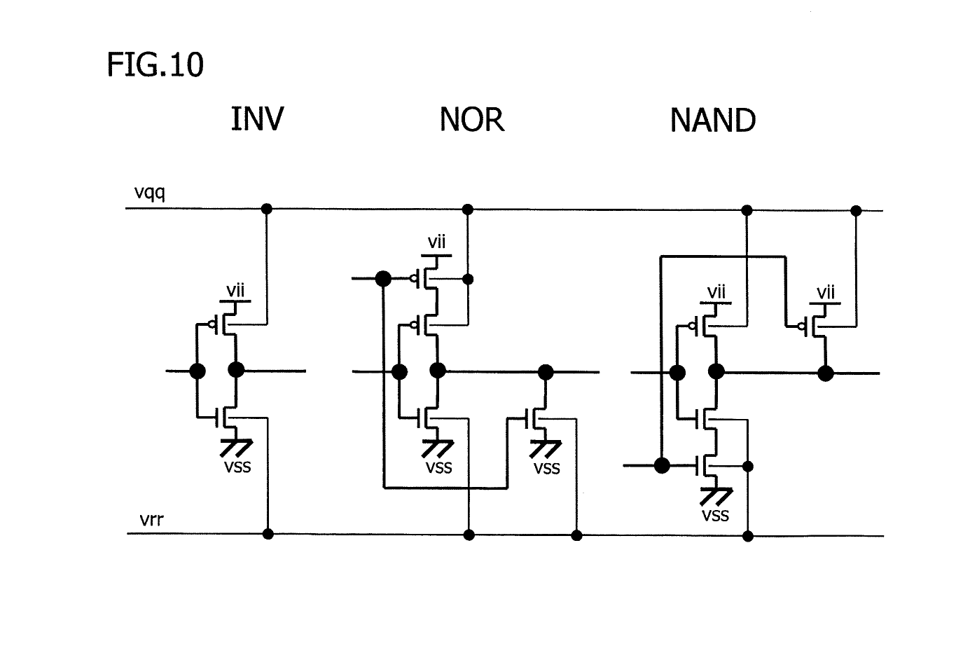

FIG. 9 is a circuit diagram of the memory cell array. The memory cell array includes bit line pairs blx and blz, word lines w/z, memory cells mcx and mcz that are respectively disposed at junctions between the bit line pairs blx and blz and the word lines w/z, and a sense amplifier sa provided on the bit line pairs blx and blz. A negative back-gate bias voltage vbb is applied to the back gates of cell transistors qx and qz of the memory cell. A positive cell plate voltage vplt is applied to the opposing electrodes of capacitors cx and cz of the memory cell.

The sense amplifier sa in FIG. 9 includes a sense amplifier circuit 80 to amplify a tiny voltage difference generated on the bit line pairs blx and blz when the word lines w/z are turned into the activated state (H level) during an active period, column gates csx and csz to select the bit line pairs blx and blz during a read-out or write-in operation, and an equalized circuit 82 to equalize the bit line pairs blx and blz during a precharge period after the read-out or write-in operation. The positive equalized voltage vble is applied to the equalized circuit 82. An equalized control signal eqlz is controlled by an equalized control signal drive circuit 87. The PMOS-side source power supply of the CMOS inverter of the equalized control signal drive circuit 87 is a voltage voo higher than a bit-line H-level voltage vblh, thereby shortening a reset time with regards to the bit lines.

During the active period, the word driver wdmade up of the CMOS inverter drives a word line w/z to the positive step-up voltage vpp to make the word line w/z into the activated state, and keeps the other word lines w/z at a negative voltage vkk to put the other word lines w/z in the inactivated state. Keeping the activated state of the word line at the positive step-up voltage vpp sufficiently puts the cell transistors qxand qz in the ON state, which allows the bit line and the node in the cell to obtain an equal potential. Similarly, keeping the inactivated state of the other word lines at the negative voltage vkk steadily puts the cell transistors qxand qz in the OFF state, thereby preventing the leak current.

Further, during the active period, sense amplifier select circuits 83 and 84 respectively put sense amplifier enable signals saez and saex into the activated states (H level, L level), allow sense amplifier drive transistors sadn (N20) and sadp (P20) to conduct, activate the sense amplifier circuit 80, and amplify the bit line pairs blx and blz. The sense amplifier circuit 80 is activated based on the supply of the bit-line H-level voltage vblh and the ground voltage vss. The bit-line H-level voltage vblh is a voltage lower than the internal power supply voltage vii.

The sense amplifier drive transistors sadn (N20) and sadp (P20) are a transistor whose size is large and are commonly provided in a plurality of sense amplifier circuits 80. Accordingly, in order to suppress the standby leak current, the negative voltage vnn is applied to the source power supply on the side of the NMOS transistor of the CMOS inverter of the sense amplifier select circuit 84, in such a manner that the sense amplifier enable signal saez in the inactivated state (L level) is lower than the source power supply vss of the sense amplifier drive transistor sadn. Similarly, the positive voltage vii is applied to the source power supply on the side of the PMOS transistor of the CMOS inverter of the sense amplifier select circuit 83, in such a manner that the sense amplifier enable signal saex in the inactivated state (H level) is higher than the source power supply vblh of the sense amplifier drive transistor sadp.

Next, during the read-out or write-in period, a column drive circuit 85 drives column gates csx and csz based on the column address. The source power supply of the side of the PMOS transistor of the CMOS inverter of the column drive circuit 85 is the voltage vii higher than the bit-line H-level voltage vblh. Accordingly, the column gates csx and csz are sufficiently put in the ON state, whereby the H-level voltage of the bit line pairs is transferred to read data bus line pairs rdbx and rdbz, or conversely, whereby the H-level voltage of write data bus line pairs wdbx and wdbz is transferred to the bit line pairs.

A data bus switch circuit 86 couples the selected bit line pairs to the read data bus line pairs rdbx and rdbz or the write data bus line pairs wdbx and wdbz in accordance with the read-out period or the write-in period.

FIG. 10 is a circuit diagram of an inverter INV, a NOR gate, and a NAND gate in the peripheral control circuit group. FIG. 10 illustrates a standard inverter INV, NOR gate, and NAND gate. The source power supply on the side of the NMOS transistor of each circuit is the ground voltage vss, and the back-gate bias voltage is the negative voltage vrr lower than the ground voltage vss. Similarly, the source power supply on the side of the PMOS transistor of each circuit is the internal power supply voltage vii, and the back-gate bias voltage is the positive voltage vqq higher than the internal power supply voltage vii. The use of the back-gate bias voltages steadily prevents the parasitic PN junction between the sources of the PMOS and NMOS transistors and the back gate from turning on. Further, the standby leak current in the OFF state is suppressed.

[Voltage Generation Circuit]

Next, one example of the voltage generation circuit of the embodiment of the present invention will be described. The voltage generation circuit includes a plurality of voltage step-up circuits. In the internal power supply startup sequence when an external power supply is turned on or when returned from a sleep state, the voltage generation circuit controls the start and stop of the operation of the voltage step-up circuits in accordance with order of priority allocated on the plurality of voltage step-up circuits while limiting the number of voltage step-up circuits, which simultaneously operate, to a predetermined number (plural units).

That is, in the basic operation of the voltage step-up circuit, when the startup is started, the output voltage is stepped up through a pumping operation. When the output voltage reaches a desired potential, the voltage step-up operation is stopped. When the output voltage is reduced or becomes shallower than the desired potential, the voltage step-up operation is restarted. However, the control circuit controls the start and stop of the operation of each voltage step-up circuit while limiting the number of voltage step-up circuits, which simultaneously carry out the step-up operation, to a predetermined plural number. Further, in accordance with the order of priority, the control circuit preferentially starts the operation of a voltage step-up circuit having higher priority and stops the operation of a voltage step-up circuit having lower priority in a manner as to prevent the predetermined plural number of voltage step-up circuits to be operated from exceeding the limit number, in the voltage step-up operation.

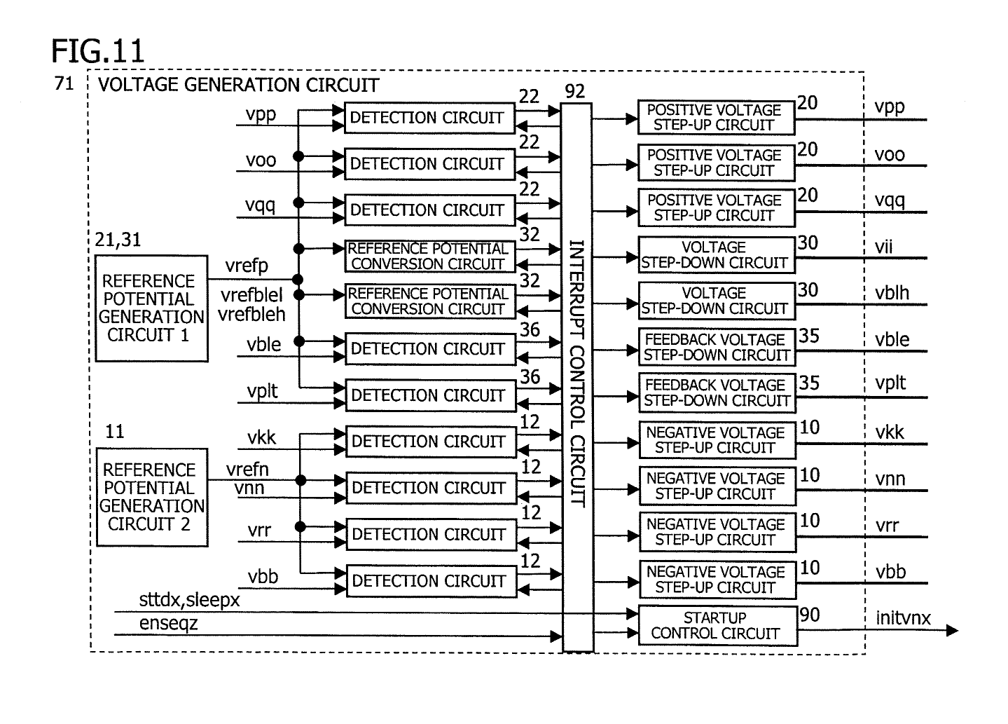

FIG. 11 is an overall configuration diagram of the voltage generation circuit of the embodiment of the present invention. The voltage generation circuit 71 includes three sets of positive voltage step-up circuits 20 that respectively generate 11 sets of internal power supply voltages vpp, voo, vqq, vii, vblh, vble, vplt, vkk, vnn, vrr, and vbb, two sets of voltage step-down circuits 30, two sets of feedback voltage step-down circuits 35, and four sets of negative voltage step-up circuits 10.

Any of the positive voltage step-up circuits 20, the voltage step-down circuits 30, and the feedback voltage step-down circuits 35 is a sort of voltage step-up circuit, which, in the internal power supply startup sequence, charges with positive charges to the parasitic capacitance of the internal power supply wire coupled to output terminals, and steps up a positive internal power supply voltage that serves as an output voltage from the ground potential to a desired positive potential. Similarly, any of the negative voltage step-up circuits 10 is a sort of voltage step-up circuit, which, in the internal power supply startup sequence, charges with negative charges to the parasitic capacitance of the internal power supply wire coupled to the output terminals, and steps up a negative internal power supply voltage that serves as an output voltage from the ground potential to a desired negative potential.

According to interrupt control circuit 92, the maximum number of voltage step-up circuits that simultaneously operate is limited, and the operation of voltage step-up circuits is controlled in accordance with the order of priority, and a common power supply voltage is supplied to the plurality of voltage step-up circuits that generate an internal power supply voltage having a different potential. The combination of the plurality of voltage step-up circuits controlled by the interrupt control circuit 92 will be described later.

The basic operation of each voltage step-up circuit (voltage step-up circuit and voltage step-down circuit in FIG. 11) is as follows.

As illustrated in FIG. 5, the positive voltage step-up circuits 20 feed back the positive internal power supply voltages vpp, voo, and vqq, which are an output voltage, to respective detection circuits 22, and start or stop the operation thereof in response to an enable signal generated in accordance with the results of comparison between the reference voltage vrefp from the reference potential generation circuits 21 and 31 and the positive internal power supply voltages vpp, voo, and vqq. The reference voltage vrefp has a potential corresponding to the potential of each output voltage.

As illustrated in FIG. 6, in response to the enable signal enrglx, the voltage step-down circuits 30 start or stop the operation of generating the output voltages vii and vblh based on the voltage vg whose potential is converted from the reference voltage vrefp by the reference potential conversion circuit 32.

As illustrated in FIG. 7, the feedback voltage step-down circuits 35 feed back the positive internal power supply voltages vble and vplt, which are the output voltages, to respective detection circuits 36 (comparators Cmp4 and Cmp5 in FIG. 7). Based on the results of comparison by the comparators, when the enable signal supenz is in the activated state (H level), the feedback voltage step-down circuits 35 start the operation thereof, and when the enable signal supenz is in the inactivated state, the feedback voltage step-down circuits 35 stop the operation thereof.

As illustrated in FIG. 4, the negative voltage step-up circuits 10 feed back the negative internal power supply voltages vkk, vnn, vrr, and vbb, which are the output voltages, to the respective detection circuits 12. The negative voltage step-up circuits 10 start or stop the operation thereof in response to the enable signal generated in accordance with the results of comparison between the reference voltage vrefn from the reference potential generation circuit 11 and the negative internal power supply voltages vkk, vnn, vrr, and vbb. The reference voltage vrefn has a potential corresponding to the potential of each output voltage.

A startup control circuit 90 puts a startup detection signal initvnx into the activated state (L level) in response to the activated state (L level) of an external power supply startup signal sttdx to be outputted when the external power supply vdd starts up, or the activated state (L level) of a sleep signal sleepx when returned from the sleep state. In response to the activated state of the startup detection signal initvnx, a sequence enable signal enseqz, which is the inverting signal of the startup detection signal initvnx, is put into the activated state (H level). In response to the activated state (H level) of the sequence enable signal enseqz, an interrupt control circuit 92 controls the start and stop of operations of the plurality of voltage step-up circuits in accordance with the order of priority with respect to the voltage step-up circuits while limiting the maximum number, out of the plurality of voltage step-up circuits that simultaneously operate, to a predetermined number.

When the output potentials of all the voltage step-up circuits to be controlled reach desired potentials, the startup control circuit 90 puts the startup detection signal initvnx into the inactivated state (H level), thereby putting the sequence enable signal enseqz into the inactivated state (L level). In response to the inactivated states, the interrupt control circuit 92 releases the control of limiting the maximum number of voltage step-up circuits that simultaneously operate and the control of the operations of the voltage step-up circuits in accordance with the order of priority. In this respect, the internal power supply startup sequence is complete. In the embodiment of the present invention, in the normal operation after the completion of the sequence, each voltage step-up circuit carries out the aforementioned basic operation in response to the enable signal outputted by the detection circuit and the like.

In the normal operational state, the stored charges in output capacitors coupled to the output terminals suppress the fluctuation of the potentials with respect to the internal power supply voltage generated by each voltage step-up circuit. Accordingly, in the normal voltage step-up operation of each voltage step-up circuit in the normal operational state, it is less likely that a large amount of consumption current occurs. Accordingly, even if the maximum number of voltage step-up circuits that simultaneously operate is not limited, it is less likely that the internal power supply voltage deviates from a desired potential, or that the desired order of high-and-low levels of the potential is changed, due to the fluctuation of the internal power supply voltage to be generated.

However, even in the normal operational state, the interrupt control circuit 92 may continue to carry out the control of the operation of the voltage step-up circuits in accordance with the order of priority while limiting the maximum number of voltage step-up circuits that simultaneously operate, as is similar to the internal power supply startup sequence above.

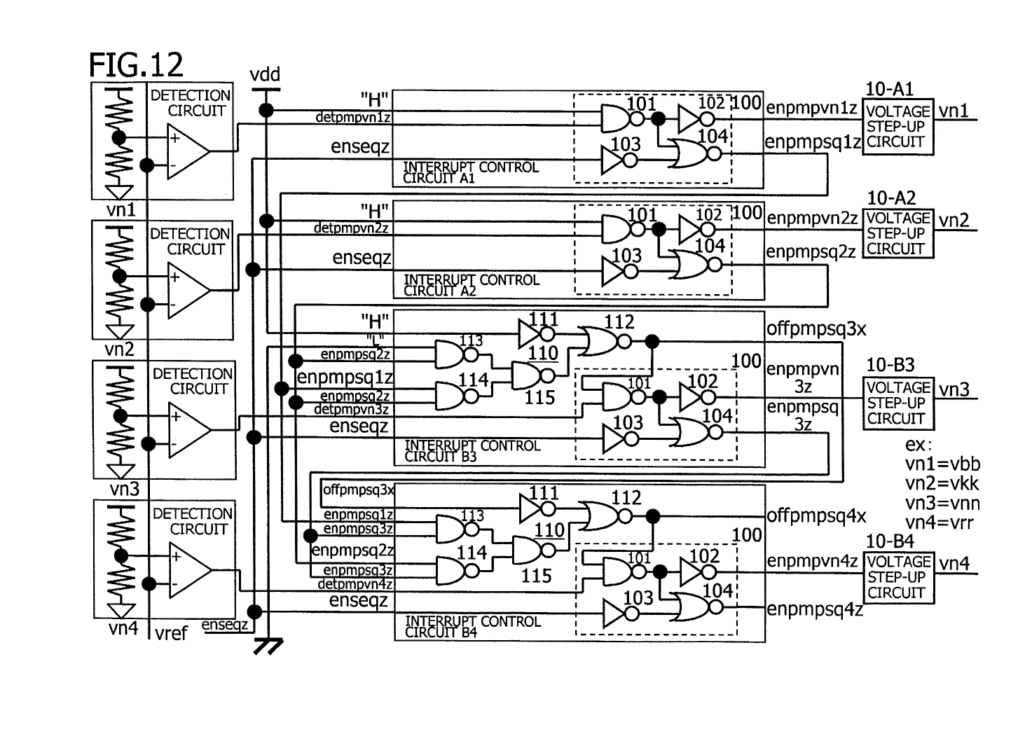

FIG. 12 is a circuit diagram of the interrupt control circuit 92 of the embodiment of the present invention. As the example, FIG. 12 illustrates an interrupt control circuit that includes four sets of voltage step-up circuits 10-A1, 10-A2, 10-B3, and 10-B4 and limits the maximum number of voltage step-up circuits that simultaneously operate to two sets, and controls the four sets of voltage step-up circuits 10-A1, 10-A2, 10-B3, and 10-B4 in the order of priority based on the output voltage vn1>vn2>vn3>vn4. As one example, the output voltages vn1, vn2, vn3, and vn4 are the internal power supply voltages vbb, vkk, vnn, and vrr, all of which are negative voltages. The magnitude of the negative potentials is deeper (the absolute value is larger) in the order of vn1>vn2>vn3>vn4 toward the negative voltage side.

The maximum number of voltage step-up circuits that simultaneously operate is two sets, so that two sets of voltage step-up circuits 10-A1, and 10-A2 having higher priority always start the operation thereof when the detection circuits activate the enable signal. In the case where the maximum number of voltage step-up circuits that simultaneously operate is less than two sets, the other two sets of voltage step-up circuits 10-B3, and 10-B4 having lower priority may start the operation thereof when the detection circuits activate the enable signal. However, even during the operation, when another voltage step-up circuit having higher priority than that of the operating voltage step-up circuits starts the operation, the operating voltage step-up circuits are forced to stop the operations thereof.

In FIG. 12, an interrupt control circuit A1 outputs a voltage step-up enable signal enpmpvn1z to control the start and stop of the operation of the voltage step-up circuit 10-A1 and a voltage step-up sequence signal enpmpsq1z to represent the state of operation thereof. The voltage step-up sequence signal enpmpsq1z is provided for other interrupt control circuits, to be used for the control of limiting the maximum number of voltage step-up circuits that simultaneously operate and the control of operations of the voltage step-up circuits in accordance with the order of priority.

The detection signal detpmpvn1z (H level) activated by the detection circuit is inputted to NAND 101 whose output is inputted to an inverter 102, whereby putting the voltage step-up enable signal enpmpvn1z into the activated state (H level). When the sequence enable signal enseqz is put in the activated state (H level) through an inverter 103 and NOR 104, the voltage step-up enable signal enpmpvn1z and the voltage step-up sequence signal enpmpsq1z become equal in logic. When the sequence enable signal enseqz is in the inactivated state (L level), the voltage step-up sequence signal enpmpsq1z is forcibly put into the inactivated state (L level), thereby releasing the sequence controls of limiting the maximum number of voltage step-up circuits that simultaneously operate and operating the voltage step-up circuits in accordance with the order of priority, according to the interrupt control circuits B3 and B4. One input of NAND 101 is always at H level, so that, when the detection circuit activates the detection signal detpmpvn1z (H level), the interrupt control circuit A1 automatically activates the voltage step-up enable signal enpmpvn1z (H level).

An interrupt control circuit A2 outputs a voltage step-up enable signal enpmpvn2z to control the start and stop of the operation of a voltage step-up circuit 10-A2 and a voltage step-up sequence signal enpmpsq2z to represent the state of operation thereof. The control operation of the interrupt control circuit A2 is the same as that of the interrupt control circuit A1 including the same circuit 100.

Next, an interrupt control circuit B3 outputs a voltage step-up enable signal enpmpvn3z to control the start and stop of the operation of a voltage step-up circuit 10-B3 and a voltage step-up sequence signal enpmpsq3z to represent the state of operation thereof. Further, the interrupt control circuit B3 generates a stop sequence signal offpmpsq3x to represent the stop of the voltage step-up circuit 10-B3.

When the stop sequence signal offpmpsq3x is inactivated (H level), the circuit 100 in the interrupt control circuit B3 similarly operates as the circuits 100 in the interrupt control circuits A1 and A2 operate. That is, when the detection signal detpmpvn3z of the detection circuit is activated (H level), the voltage step-up circuit 10-B3 starts operating. When the detection signal detpmpvn3z is inactivated (L level), the voltage step-up circuit 10-B3 is forcibly stopped. However, when the stop sequence signal offpmpsq3x is activated (L level), the voltage step-up enable signal enpmpvn3z and the voltage step-up sequence signal enpmpsq3z are forcibly inactivated (L level) by NAND 101. As a result, the voltage step-up circuit 10-B3 is forcibly stopped.

On the other hand, according to the circuit made up of an inverter 111, NANDs 113 to 115, and NOR 112 in the interrupt control circuit B3, when the voltage step-up circuits 10-A1 and 10-A2 simultaneously operate, and the step-up sequence signals enpmpsq1z and enpmpsq2z are both activated (H level), the stop sequence signal offpmpsq3x is activated (L level) by NAND 114, and the voltage step-up enable signal enpmpvn3z is inactivated (L level) by the circuit 100, and the voltage step-up circuit 10-B3 is forcibly stopped. It is noted that NAND 113 and an inverter 111 are unnecessary elements in the interrupt control circuit B3, but are provided to have the same circuit configuration as that of an interrupt control circuit B4.

Lastly, the interrupt control circuit B4 outputs a voltage step-up enable signal enpmpvn4z to control the start and stop of the operation of the voltage step-up circuit 10-B4 and a voltage step-up sequence signal enpmpsq4z to represent the state of operation thereof. Further, the interrupt control circuit B4 generates a stop sequence signal offpmpsq4x to represent the stop of the voltage step-up circuit 10-B4.

The circuit 100 in the interrupt control circuit B4 is of the same configuration as that of the circuit 100 in the interrupt control circuit B3 and operates in the same way. On the other hand, according to the inverter 111, NANDs 113 to 115, and NOR 112 in the interrupt control circuit B4, the stop sequence signal offpmpsq4x is activated (L level) respectively (1) by the inverter 111 when the voltage step-up circuits 10-A1 and 10-A2 simultaneously operate, and the step-up sequence signals enpmpsq1z and enpmpsq2z are both activated (H level), so that the stop sequence signal offpmpsq3x is activated (L level), (2) by NAND 113 when the voltage step-up circuits 10-A1 and 10-B3 simultaneously operate, and the step-up sequence signals enpmpsq1z and enpmpsq3z are both activated (H level), and (3) by NAND 114 when the voltage step-up circuits 10-A2 and 10-B3 simultaneously operate, and the step-up sequence signals enpmpsq2z and enpmpsq3z are both activated (H level). In response to the activated stop sequence signal offpmpsq4x, the voltage step-up enable signal enpmpvn4z is inactivated (L level) by the circuit 100, and the voltage step-up circuit 10-B4 is forcibly stopped. In contrast, when all the conditions (1), (2), and (3) above are not established, the number of voltage step-up circuits that simultaneously operate does not reach the maximum number, that is, two sets. Accordingly, the stop sequence signal offpmpsq4x is inactivated (H level), the voltage step-up circuit 10-B4 becomes in an operable state. In this case, when a detection signal detpmpvn4z is activated (H level) by the circuit 100, the voltage step-up circuit 10-B4 starts the operation thereof, and when the detection signal detpmpvn4z is inactivated (L level), the voltage step-up circuit 10-B4 stops.

In order to detect the aforementioned condition (1), it may be such that there is provided a NAND gate to which the step-up sequence signals enpmpsq1z and enpmpsq2z are inputted, and the output of the NAND gate is inputted to the inverter 111 in the diagram.

Thus, with respect to the interrupt control circuits B3 and B4 corresponding to voltage step-up circuits having lower priority, the control of limiting the maximum number of voltage step-up circuits that simultaneously operate, and the control of operation of the voltage step-up circuits in accordance with the order of priority is achieved based on the step-up sequence signals and the stop sequence signals.

In the interrupt control circuit in FIG. 12, the number of voltage step-up circuits can be increased to five or more. For example, in the case where the number of voltage step-up circuits is five, and the maximum number of voltage step-up circuits that simultaneously operate is two, an interrupt control circuit corresponding to the voltage step-up circuit having fifth priority is added to the circuit illustrated in FIG. 12. The interrupt control circuit is represented as a circuit B5 of the modification of the interrupt control circuit B4 of FIG. 12, wherein the stop sequence signal offpmpsq4x is inputted to the inverter 111, three units of NANDs are used instead of NANDs 113 and 114, and the step-up sequence signals enpmpsq1z/enpmpsq4z, enpmpsq2z/enpmpsq4z, enpmpsq3z/enpmpsq4z are inputted to respective NANDs, and the simultaneous operation of the output voltages vn1 and vn4, the simultaneous operation of the output voltages vn2 and vn4, or the simultaneous operation of the output voltages vn3 and vn4 may respectively be detected.

The interrupt control circuit in FIG. 12 is applied to the case where N sets of voltage step-up circuits are included in a manner as to carry out the control of limiting the maximum number of voltage step-up circuits that simultaneously operate to M sets. The circuits 100 alone are provided for M sets of interrupt control circuits in order of priority from highest. The interrupt control circuits in order of priority from (M+1)th to Nth include the circuits 100 and NANDs that input the combinations of M sets of the step-up sequence signals enpmpqKz from the voltage step-up circuits having higher priority. The NANDs correspond to NANDs 113 and 114 in FIG. 12 and are provided for each combinations of M sets. NAND 115 and NOR 114 similar to those illustrated in FIG. 12 are also included.

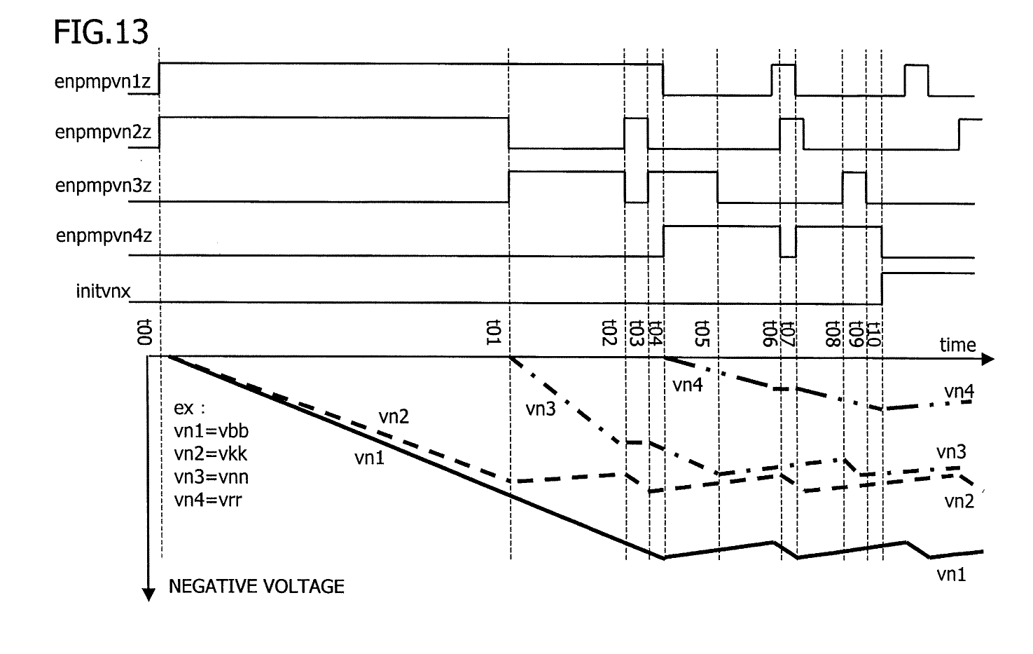

The FIG. 13 is a timing chart of internal power supply startup sequence illustrated as one example. As represented in the example of FIG. 12, FIG. 13 illustrates the internal power supply startup sequences of four sets of voltage step-up circuits 10-A1, 10-A2, 10-B3, and 10-B4 and illustrates the voltage step-up enable signals enpmpvn1z to enpmpvn4z respectively corresponding to the four sets of voltage step-up circuits and the signal waveforms of the output signals vn1 to vn4 outputted from each voltage step-up circuit.

When the startup control circuit 90 puts the startup detection signal initvnx into the activated state (L level), at a time t00, the voltage step-up enable signals enpmpvn1z and enpmpvn2z are both activated (H level), whereby the voltage step-up circuits 10-A1 and 10-A2 simultaneously start the voltage step-up operation. This is because the maximum number of voltage step-up circuits that simultaneously operate is limited to two sets, and two sets of the voltage step-up circuits having the highest priority start the operation thereof. Accordingly, the consumption current of the voltage step-up circuits is suppressed, and the peak current with respect to the internal power supply vii supplied to the voltage step-up circuits is also suppressed. Accordingly, the power supply noise in the internal power supply vii is suppressed, and the order of potentials of the internal power supply voltages vn1 and vn2 to be outputted is appropriately maintained.

When the internal power supply voltage vn2 reaches a desired voltage at a time t01, one another voltage step-up circuit may carry out the voltage step-up operation instead of the internal power supply vn2, which allows the internal power supply vn3 to start the voltage step-up operation. However, the internal power supply voltage vn2 becomes shallower (the absolute value decreases) from the desired voltage with a lapse of time due to the current consumption for voltage detection and the leak current.

Shortly, the voltage step-up operation of the internal power supply vn2 is demanded to be carried out again at a time t02. In this time, the internal power supplies vn1 and vn3 have been executing the voltage step-up operation. When the internal power supply vn2 simultaneously carries out the voltage step-up operation, the number of voltage step-up circuits in operation is increased to three units. Accordingly, the voltage step-up operation of the internal power supply vn3 having lower priority than that of the internal power supply vn2 is temporarily suspended, and the voltage step-up operation of the internal power supply vn2 is carried out instead.

At a time t03, when the internal power supply voltage vn2 reaches the desired voltage again, and the voltage step-up operation is stopped, the voltage step-up operation of the internal power supply vn3 that is temporarily suspended is restarted.

At a time t04, when the voltage step-up operation of the internal power supply vn1 is complete, the voltage step-up operation of the internal power supply vn4 is restarted. At a time t05, the voltage step-up operation of the internal power supply vn3 is complete.

Before and after a time t06, the voltage step-up operation of the internal power supplies vn1 and vn2 is demanded again, so that the voltage step-up operation of the internal power supply vn4 is temporarily suspended, and the voltage step-up operation of the internal power supplies vn1 and vn2 is restarted. Subsequently, before and after a time t07, the voltage step-up operation of the internal power supplies vn1 and vn2 is complete, and at a time t07, the voltage step-up operation of the internal power supply vn4 is restarted.

From a time t08 to a time tog, the internal power supply vn3 carries out the voltage step-up operation again. When the internal power supply voltage vn4 continues to carry out the voltage step-up operation, the number of the voltage step-up circuits that simultaneously operate is two, which allows the internal power supply voltage vn4 to continuously carry out the voltage step-up operation.

At a time t10, the internal power supply voltage vn4 reaches the desired potential, and the voltage step-up operation is stopped. At this time point, the number of voltage step-up circuits under operation is reduced to zero.

When the startup control circuit 90 detects the completion of the power supply startup of all the internal power supplies vn1 to vn4, the startup control circuit 90 inactivates the startup detection signal initvnx (H level) and inactivates the sequence enable signal enseqz (L level), whereby the interrupt control circuit 92 completes the internal power supply startup sequence control. Accordingly, in the normal operation after the startup sequence, each voltage step-up circuit of the voltage generation circuit is no longer put under the internal power supply startup sequence control based on the limitation in the maximum number of voltage step-up circuits that simultaneously operate, and the control in accordance with the order of priority. Each voltage step-up circuit starts and stops the voltage step-up operation in response to the output of the detection circuit and the like.

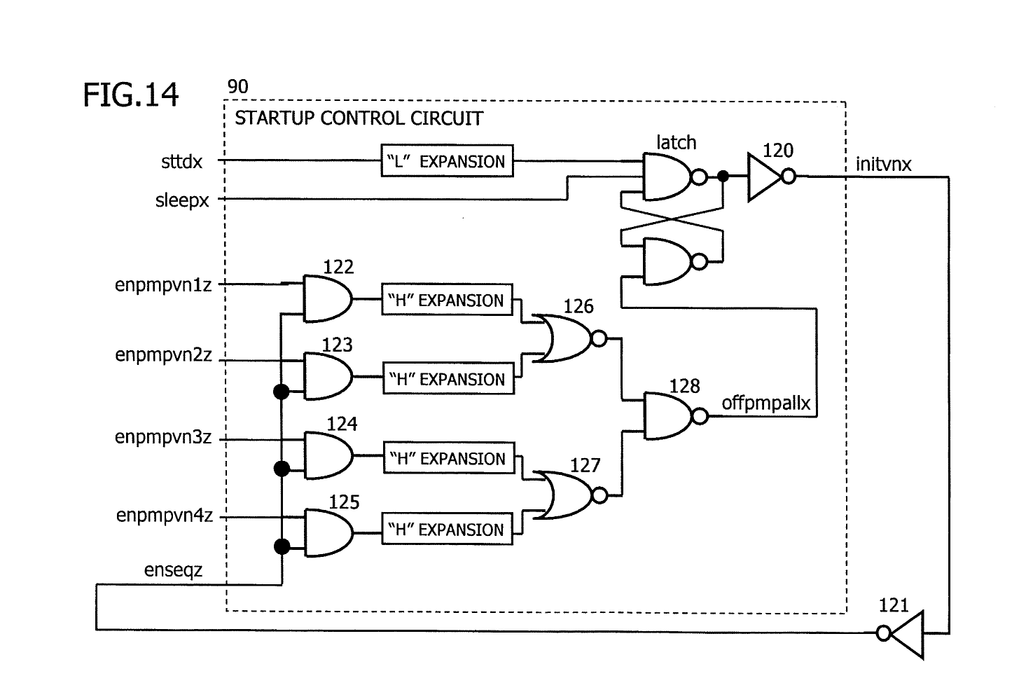

FIG. 14 is a circuit diagram of the startup control circuit. In the startup control circuit 90, the latch circuit latches the power supply startup signal sttdx (L level) that is activated when the external power supply is turned on, or the sleep signal sleepx (L level) that is activated when returned from the sleep state, and the startup detection signal initvnx is activated (L level), and the sequence enable signal enseqz is activated (H level) by an inverter 121, thereby starting the internal power supply startup sequence. When all the internal power supply voltages vn1 to vn4 are stepped up to the desired potentials, and the startups of the internal power supplies are complete, the voltage step-up enable signals enpmpvn1z to enpmpvn4z are all inactivated (L level), and a complete stop signal offpmpallx is activated (L level), thereby inverting the latch circuit. As a result, the startup detection signal initvnx is inactivated (H level), and the sequence enable signal enseqz is inactivated (L level) by the inverter 121, and the internal power supply startup sequence operation is complete.

In the examples of FIGS. 13 and 14, all the voltage step-up circuits under the internal power supply startup sequence control generate the negative voltage. However, the embodiment of the present invention may be applied in the case where the plurality of voltage step-up circuits under the internal power supply startup sequence control all generate the positive voltage, and also in the case where the plurality of voltage step-up circuits under the internal power supply startup sequence control are made up of circuits that generate the positive voltage and circuits that generate the negative voltage.

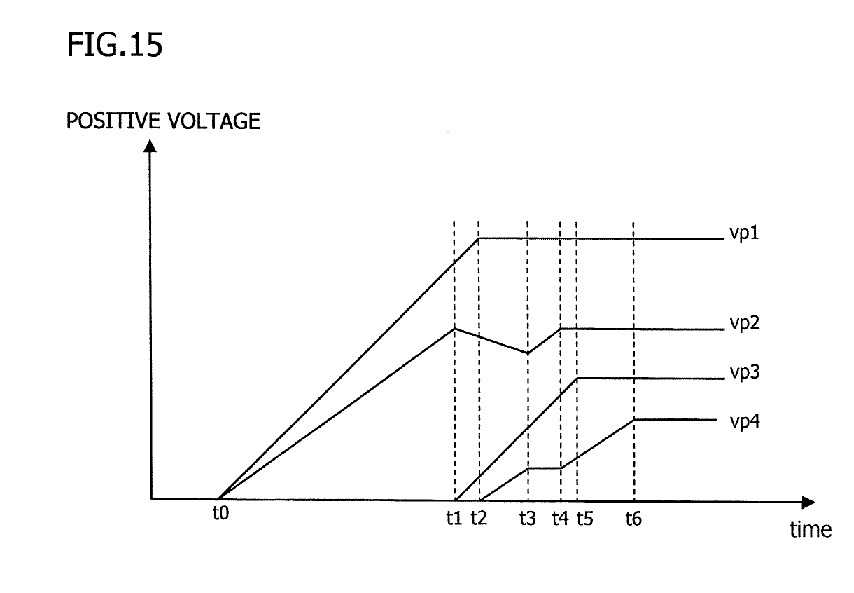

FIG. 15 is a graph of the startup sequence of the voltage step-up circuits, illustrated as another example. This example represents a case where all the four sets of voltage step-up circuits to be controlled generate the positive voltage, and the order of priority becomes higher in accordance with the magnitude of the positive potentials, which are represented in order of vp1>vp2>vp3>vp4.

In the example of FIG. 15, the internal power supply startup sequence starts at a time t0, at first, the voltage step-up operations of two sets of the internal power supplies vp1 and vp2 respectively having the first and second highest priority are started. At a time t1, the voltage step-up operation of the internal power supply vp2 is complete, and the voltage step-up operation of the internal power supply vp3 having the third highest priority is started. Similarly, at a time t2, the voltage step-up operation of the internal power supply vp1 is complete, and the voltage step-up operation of the internal power supply vp4 having the fourth highest priority is started. Subsequently, at a time t03, the internal power supply voltage vp2 is reduced, which stops the voltage step-up operation of the internal power supply vp4 having the lowest priority in operation, and the voltage step-up operation of the internal power supply vp2 is restarted instead. At a time t04, the voltage step-up operation of the internal power supply vp2 is complete, and the voltage step-up operation of the internal power supply vp4 is restarted. Then, at a time t05, the voltage step-up operation of the internal power supply vp3 is complete, and at a time t06, the voltage step-up operation of the internal power supply vp4 is complete, and all the voltage step-up operations are complete.

Thus, the relation of magnitude of potentials of the four sets of positive internal power supplies vp1 to vp4 is maintained, and the number of voltage step-up circuits that simultaneously operate is limited to two sets, whereby preventing noise from occurring in the internal power supplies whose voltages are supplied to the voltage step-up circuits.

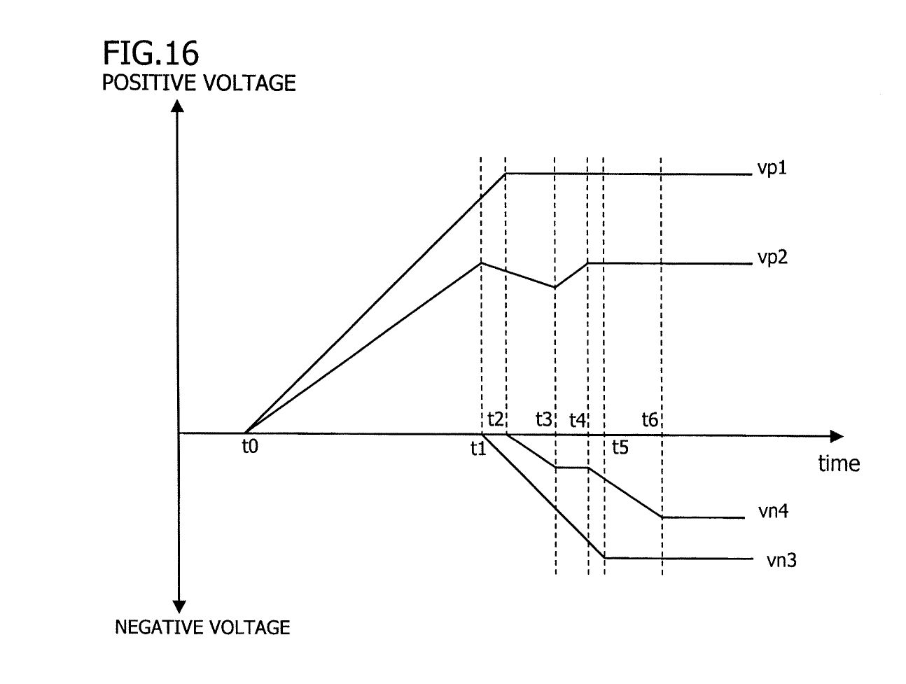

FIG. 16 is a graph of the startup sequence of the voltage step-up circuits, illustrated as another example. This example represents a case where the four sets of voltage step-up circuits to be controlled generate two positive voltages vp1 and vp2 and two negative voltages vn3 and vn4, and the order of priority is such that priority of positive potentials is higher than that of negative potentials, and the priority of higher absolute value of the potentials is higher than that of lower ones. Accordingly, the order of priority is represented as vp1>vp2>vn3>vn4. In general, logic circuits operate based on a signal having a positive potential. The priority of the positive potential is set higher than that of negative potential, so that the malfunction of logic circuits would be prevented. The internal power supply having the negative potential is mainly used to suppress the standby leak current. Accordingly, the order of priority of the power supply having the negative potential may be low.

In the example of FIG. 16, the internal power supply startup sequence starts at a time t0, at first, the voltage step-up operations of two sets of the internal power supplies vp1 and vp2 respectively having the first and second highest priority are started. At a time t1, the voltage step-up operation of the internal power supply vp2 is complete, and the voltage step-up operation of the negative potential of the internal power supply vn3 having the third highest priority is started. Similarly, at a time t2, the voltage step-up operation of the internal power supply vp1 is complete, and the voltage step-up operation of the negative potential of the internal power supply vn4 having the fourth highest priority is started. Subsequently, at a time t03, the internal power supply voltage vp2 is reduced, which stops the voltage step-up operation of the internal power supply vn4 having the lowest priority in operation, and the voltage step-up operation of the internal power supply vp2 is restarted instead. At a time t04, the voltage step-up operation of the internal power supply vp2 is complete, and the voltage step-up operation of the internal power supply vn4 is restarted. Then, at a time t05, the voltage step-up operation of the internal power supply vn3 is complete, and at a time t06, the voltage step-up operation of the internal power supply vn4 is complete, and all the voltage step-up operations are complete.

As described above, in the internal power supply startup sequence of a plurality of voltage step-up circuits which respectively generate a different internal power supply voltage, and to which a common internal power supply voltage is supplied so as to operate, the maximum number of voltage step-up circuits that simultaneously operate is limited to a plural number less than the total number of voltage step-up circuits, and the voltage step-up operations are controlled in accordance with order of priority corresponding to the voltage step-up circuits. Consequently, in the internal power supply startup sequence, the amount of peak currents from the voltage step-up circuits is prevented from increasing while preventing the reversal of the potential of internal power supply voltage to be generated, whereby suppressing the generation of unnecessary internal power supply voltage, which causes malfunction.

In the embodiment of the present invention, the maximum number of voltage step-up circuits that simultaneously operate is limited to a predetermined number, and the voltage step-up operations are controlled in accordance with order of priority. However, even in the case where the control of the voltage step-up operations in accordance with order of priority is not carried out, and the internal power supply startup sequence control is carried out merely in a manner that the maximum number of voltage step-up circuits that simultaneously operate is limited to the predetermined number, the power supply noise may be suppressed, and the potentials of internal power supply voltages to be generated are prevented deviating from a desired potential.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. A voltage generation circuit comprising:
M sets of first voltage step-up circuits configured to start a voltage step-up operation for increasing an absolute value of an output voltage in response to a power supply startup, and configured to stop the voltage step-up operation when the output voltage reaches a first voltage that is independently set for each first voltage step-up circuit, the M being two or more;
a plurality of second voltage step-up circuits configured to start the voltage step-up operation in response to a control signal and configured to stop the voltage step-up operation when the output voltage reaches a second voltage that is independently set for each second voltage step-up circuit; and
a control circuit configured to control such that the plurality of second voltage step-up circuits operate in accordance with order of priority while limiting a maximum number of voltage step-up circuits that simultaneously operate, out of the first voltage step-up circuits and the second voltage step-up circuits, to the M sets.

2. The voltage generation circuit according to claim 1,
wherein a common power supply voltage is supplied to the first and second voltage step-up circuits, and the output voltages are generated by the voltage step-up operation.

3. The voltage generation circuit according to claim 1,
wherein the first and second output voltages of the first and second voltage step-up circuits are different to each other.

4. The voltage generation circuit according to claim 3,
wherein an absolute value of the first voltage of the first voltage step-up circuit is higher than an absolute value of the second voltage of the second voltage step-up circuit, and the order of priority increases as the absolute value of the second voltage of the second voltage step-up circuit increases.

5. The voltage generation circuit according to claim 3,
wherein the first and second voltage step-up circuits include a positive voltage generation circuit whose first and second voltages are higher than the power supply voltage supplied to the first and second voltage step-up circuits, or a negative voltage generation circuit whose first and second voltages are a negative voltage.

6. The voltage generation circuit according to claim 5,
wherein the first and second voltage step-up circuits include the negative voltage generation circuit, and the order of priority is set higher as the first and second voltages of the negative voltage generation circuit are deeper on a negative potential side.

7. The voltage generation circuit according to claim 5,
wherein the first and second voltage step-up circuits include the positive voltage generation circuit, and the order of priority is set higher in accordance with an order of a magnitude of the first and second voltages of the positive voltage generation circuit.

8. The voltage generation circuit according to claim 5,
wherein the first and second voltage step-up circuits include both the positive voltage generation circuit and the negative voltage generation circuit, and first priority is set higher in accordance with the magnitude of the first or second voltage of the positive voltage generation circuit, and second priority lower than the first priority is set higher as the first or second voltage of the negative voltage generation circuit is deeper on the negative potential side.

9. The voltage generation circuit according to claim 3,
wherein, in a normal operational state after all the output voltages of the first and second voltage step-up circuits reach the first voltage and the second voltage, the control circuit releases the control of limiting the maximum number of voltage step-up circuits that simultaneously operate and the control of operating the voltage step-up circuits in accordance with the order of priority, and
wherein the first and second voltage step-up circuits respectively carry out the voltage step-up operation thereof every time the respective output voltages are reduced to a voltage lower than the first and second voltage.

10. The voltage generation circuit according to claim 3,
wherein, in a normal operational state after all the output voltages of the first and second voltage step-up circuits reach the first voltage and the second voltage, the control circuit continues to carry out the control of limiting the maximum number of voltage step-up circuits that simultaneously operate and the control of operating the voltage step-up circuits in accordance with the order of priority.

11. A voltage generation circuit comprising:
N sets of voltage step-up circuits configured to start a voltage step-up operation for increasing an absolute value of an output voltage and configured to stop the voltage step-up operation when the output voltage reaches a step-up voltage that is independently set for each voltage step-up circuit; and
a control circuit configured to control such that the N sets of voltage step-up circuits operate in accordance with order of priority while limiting a maximum number of voltage step-up circuits that simultaneously operate, out of the N sets of voltage step-up circuits, to a plural number lower than the N sets.

12. The voltage generation circuit according to claim 11,
wherein a common power supply voltage is supplied to the N sets of voltage step-up circuits, and the output voltages are generated by the voltage step-up operation.

13. The voltage generation circuit according to claim 11,
wherein the step-up voltages of the N sets of voltage step-up circuits are different to each other.

14. The voltage generation circuit according to claim 13,
wherein the order of priority is set higher as an absolute value of the step-up voltage of the N sets of voltage step-up circuit increases.

15. The voltage generation circuit according to claim 13,
wherein the N sets of voltage step-up circuit include a positive voltage generation circuit whose step-up voltage is higher than the power supply voltage supplied to the N sets of voltage step-up circuits, or a negative voltage generation circuit whose step-up voltage is a negative voltage.

16. The voltage generation circuit according to claim 13,
wherein in a normal operational state after all the output voltages of the N sets of voltage step-up circuits reach the step-up voltage that is independently set for each voltage step-up circuit, the control circuit releases the control of limiting the maximum number of voltage step-up circuits that simultaneously operate and the control of operating the voltage step-up circuits in accordance with the order of priority, and
wherein the N sets of voltage step-up circuits respectively carry out the voltage step-up operation thereof every time the respective output voltages are reduced to a voltage lower than the step-up voltage independently set for each voltage step-up circuit.

17. A voltage generation circuit comprising:
N sets of voltage step-up circuits configured to start a voltage step-up operation in a manner as to increase an absolute value of an output voltage and configured to stop the voltage step-up operation when the output voltage reaches a step-up voltage that is independently set for each voltage step-up circuit; and
a control circuit configured to control such that N sets of voltage step-up circuits operate by limiting a maximum number of voltage step-up circuits that simultaneously operate, out of the N sets of voltage step-up circuits, to a plural number lower than the N sets.
